(19) United States
(12) Patent Application Publication
(10) Pub. No.: US 2015/0083863 A1
(43) Pub. Date: Mar. 26, 2015

(54) DEICING OF A SURFACE OF STRUCTURES IN GENERAL SUCH AS WIND TURBINE BLADES, AIRCRAFT WINGS USING INDUCTION OR RADIATION

(71) Applicant: JKA Kemi AB, Sollentuna (SE)

(72) Inventors: Joachim Karthäuser, Sollentuna (SE); Stein Dietrichson, Fredrikstad (NO)

(73) Assignee: JKA Kemi AB, Sollentuna (SE)

(21) Appl. No.: 14/399,232

(22) PCT Filed: Jan. 25, 2013
(86) PCT No.: PCT/SE2013/050058

§ 371 Date: Nov. 6, 2014

(30) Foreign Application Priority Data
May 16, 2012 (SE) 1200302-6
Sep. 13, 2012 (SE) 1200556-7

(51) Int. Cl. B64D 15/12; H02G 7/16

(52) U.S. Cl. CPC B64D 15/12; H02G 7/16
USPC 244/134 D; 219/201; 219/209

(57) ABSTRACT

A method is provided which allows the facile deicing of a surface of a structure in general. Electromagnetic induction or IR/Microwave radiation is used to heat up a layer or a coating on said surface of the structure in general whereby said layer preferably contains conductive particles such as carbon nano particles, such as graphite, carbon nano tubes, carbon nano cones, metal in powder form, metalized glass beads, carbon fibers, chopped or as woven structure, etc all collectively named Carbon Nano Tubes (CNTs) or cones or metallic particles at concentrations above 0.01% by weight. Heat conductors such as boron nitride may be used to improve the heat transfer to the surface. Constructions are disclosed which shield the microwave emitters from lightning receiving elements, and which protect the complete structure during lightning events. Radiation can be supplied both from the inside of the structure as well as from the outside.

### FIELD OF THE INVENTION

The invention relates to a method for deicing of a surface of a structure in general and predominantly made of polymeric materials which requires deicing at certain times.

### BACKGROUND OF THE INVENTION

Ice accretion is a major problem in the aircraft, wind power, marine and other industries. Ice accretion on aircraft wings can destabilize an aircraft within a few minutes. On wings of wind power machines, ice accretion is not desired because the extra weight means increased mechanical stress for the unit, and the aerodynamic performance and therefore energy generation is negatively affected. In marine, e.g. ships and off-shore oil platforms, and other applications, e.g. overhead power lines, ice accretion means increased weight and associated safety risks. In all these applications, methods are desired which allow efficient deicing at reasonable costs.

Many systems are known in the field. Vibration is used in some disclosures to remove ice, e.g. in U.S. Pat. No. 6,890,152 where icy conditions can be detected and at least a portion of a wind turbine blade is caused to vibrate, and WO 2009/019696 where an eccentric mass is rotated in an aircraft wing, also to cause shedding of ice due to vibration.

Various electrical heating foils and constructions are known, e.g. WO 98/53200 where electrical heating as part of a composite structure is embedded in fabric. WO 2011/018695 discloses a thermoelectric film covering at least part of the leading edge or trailing edge of a wind turbine air foil. WO 2006/108125 discloses an electrothermal deicing apparatus consisting of conducting materials in a predetermined pattern. The material also absorbs radiation such as enemy radar; however, heating via absorption is not mentioned.

EP 1 187 988 discloses combined heating/deicing and lighting protection of wind turbine blades. Finally, EP 0680 878A1 discloses an electrothermal deicing system for an airfoil, comprising a temperature sensor, ice shed zones and ant-icing parting strips.

Microwave radiation as means to accomplish deicing is known from U.S. Pat. No. 4,060,212 (microwaves are led into helicopter blades in order to heat or melt ice directly) and WO 2001/74661 (similarly, but with defined frequencies such as between 900 MHz and 20 GHz). However, in these disclosures the purpose is to heat and thereby melt the ice directly, using frequencies which are absorbed by frozen water. These techniques seem not to be widespread, possibly due to low efficiency—solid ice is not efficient as microwave absorber and constructive difficulties.

### SUMMARY OF THE INVENTION

The object of the invention disclosed here to solve the problem of the current art by providing a simpler method which does not require electrical connections to the deicing layer and which improves the absorption of electromagnetic waves by the material at a desired location, preferably close to the ice layer. Avoiding these electrical contacts or electrodes is possible electromagnetic induction or by radiation, preferably using infrared or microwave emitters (such as magnetrons or klystrons), depending on the case as explained below. It has been found that carbon nano particles, such as graphite, carbon nano tubes, carbon nano cones, metal in powder form, metalized glass beads, carbon fibers, chopped or as woven structure, etc ail collectively named Carbon Nano Tubes (CNTs) which are well dispersed in a polymeric matrix absorb readily microwave radiation. Absorption of radiation leads to a temperature increase which is sufficient to melt ice in the vicinity of a layer containing these CNTs. As electrons are easily moved within a single CNT, it is also possible to cause electron movement by electromagnetic induction, e.g. caused by a strong alternating current in vicinity to the CNTs. Which method is chosen depends on the application. In the following, examples are given describing specific embodiments of the invention. A common feature for all CNTs is that they are electrically conductive.

According to the invention this object is achieved by providing a method for deicing of a surface of a structure in general and predominantly made of polymeric materials which require deicing at certain times, comprising the steps of:
providing a composition comprising at least one material heatable by microwave or infrared radiation or electromagnetic induction,
placing the composition close to an area of said structure in general, whereby the composition may undergo chemical reaction such as polymerization or hardening before, during or after placing the composition at said area, and whereby said composition may be covered by a paint, a gel coat, a foil or other protection,
heating said composition as and when required without direct electrical contact, said heating being achieved by means such as microwave or infrared irradiation or electromagnetic induction.

Preferred embodiments are given in the dependent patent claims.

### DESCRIPTION OF THE FIGURES

The invention is described in more detail below with references to the attached drawings, in which

FIG. 1 shows a schematic wind turbine blade in profile, and

FIG. 2 shows a schematic drawing of deicing of wind power wings through microwave radiation whereby the wings are irradiated from the outside.

### DESCRIPTION OF PREFERRED EMBODIMENTS

It has been found that CNTs which are well dispersed in a polymeric matrix absorb readily microwave radiation. Absorption of radiation leads to a temperature increase which is sufficient to melt ice in the vicinity of a layer containing these CNTs. As electrons are easily moved within a single CNT, it is also possible to cause electron movement by electromagnetic induction, e.g. caused by a strong alternating current in vicinity to the CNTs. Which method is chosen depends on the application. In the following, examples are given describing specific embodiments of the invention.

The invention disclosed here solves the problem of the current art by providing a simpler method which does not require electrical connections to the deicing layer. Avoiding these electrical contacts or electrodes is possible by electromagnetic induction or by radiation, preferably using infrared or microwave emitters (such as magnetrons or klystrons), depending on the case (see examples). It has been found that CNTs which are well dispersed in a polymeric matrix absorb readily microwave radiation. Absorption of radiation leads to a temperature increase which is sufficient to melt ice in the vicinity of a layer containing these CNTs. As electrons are easily moved within a single CNT, it is also possible to cause electron movement by electromagnetic induction, e.g. caused by a strong alternating current in vicinity to the CNTs. Which method is chosen depends on the application. In the following, examples are given describing specific embodiments of the invention.

The polymer composition preferably comprises thermoplastics such as polyethylene, polypropylene, PET, polycarbonate or thermosets such as polyurethane, epoxy or phenolic resin or rubber such as vulcanized rubber, thermoplastic elastomer, polyurethane rubber or silicone rubber, and optionally fillers such as heat conductive materials such as boron nitride.

The surface of the structure to be de-iced is predominantly made of a polymeric material or combinations of polymer c materials which is(are) possibly reinforced. By predominantly it is meant that more than 50% of the surface of the structure to be deiced is made of polymeric material(s), preferably more than 70%, particularly more than 90%, excluding inorganic materials such as glass and carbon fiber. It should be understood that these values are relevant for the structure. The surface as such, i.e. the outermost layer analyzed at molecular level, may be close to 100% polymeric.

Preferably, in one embodiment the layer which absorbs microwave radiation is placed very close, such as less than 0.1 millimeter below the surface.

The composition may be applied as a coating of between 10 micrometer and 1 millimeter thickness, or as prefabricated. coating on glass fiber or textile.

Preferably, the CNTs form part of the composition with at least 0.5% by weight or at least so much that at least 10% of the emitted IR or microwave radiation is absorbed thereby heating the composition, whichever percentage is the lower.

### EXAMPLE 1

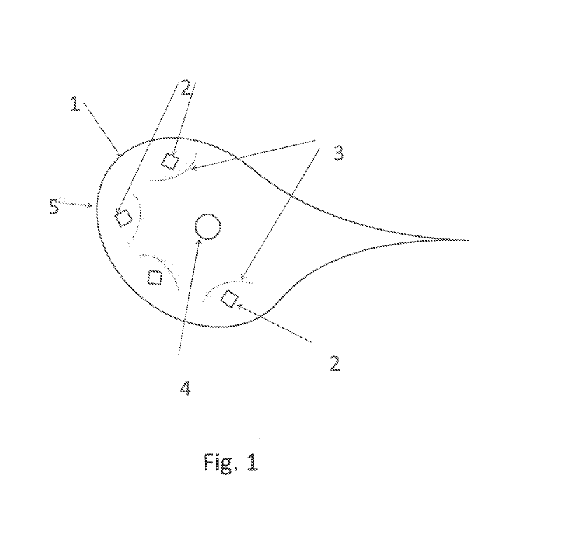

FIG. 1 illustrates a structure in general in the form of a cross-section of a wind turbine blade having a leading edge 5 and provided with an outer skin composition 1, containing a layer comprising materials, such as CNTs, which can absorb IR/microwave radiation, at least one microwave emitter or magnetron 2, possible shielding elements 3 and lightning protection system 4, respectively. The lightning protection system 4 is typically a cable.

An aircraft wing is built similarly except that deicing is often only required at the leading edge area.

As shown the wind turbine blade, preferably in the form of a polymeric blade, is coated using a composition 1 containing more than 0.1% weight of CNTs. The composition 1 may preferably comprise epoxy or polyurethane or materials which are compatible with the construction material of the blade. The composition may be coated onto textile or a woven or non-woven carrier to simplify the production. The composition as such may be very weak electrically conductive, such as below 1 Ohm*m (resist city)or may be as conductive or more as doped semiconductors. Other conductive particles such as silver coated micro glass beads or metal powder, e.g. aluminium or zinc powder, may be added to modify the absorption efficiency of this layer. It is preferred to add heat conductive particles such as boron nitride or similar to the coating, ideally on the surface of the coating facing the outermost layer. The best mode is using materials which exhibit fair mechanical strength and good adhesion to the inner composite construction and the outermost paint or gel coat. That compromise is achieved typically between 0.5 and 10%, ideally between 1 and 8% CNTs. However, said concentrations are meant as guidance only, they can vary depending upon whether or not graphite or metal-coated glass beads are used, or how thick a microwave-absorbing layer is chosen for other reasons. A layer containing such a weakly conductive composition is conveniently heated by one or more magnetron placed within the hollow wing structure. Various magnetrons are available, and their resonance frequency can be tuned. Magnetrons used for warming up food, emitting 2.45 Gigahertz, are perfectly suitable and efficient at converting electricity to radiation. The radiation is ideally completely absorbed by the composition containing CNTs, causing the layer to heat up, thereby ensuring deicing.

As shown in FIG. 1 microwave emitters or magnetrons 2 are equipped with shielding elements 3 such that induction of a current in a lightning protection system 4 is avoided. Most importantly, the magnetrons irradiate an area called leading edge 5 of the blade because ice accretion there causes immediate reduction of the aerodynamic performance of the blade. Irradiating other areas, e.g. the full blade, is necessary if the complete blade is covered with snow or ice, e.g. after a shut-down or other stand-still of the turbine in wintertime.

In one preferred embodiment, at least one magnetron is placed near the nacelle, and the microwave radiation is guided to the area which shall be irradiated by means of a waveguide, typically a hollow aluminium profile (e.g. 10*10 cm, and 1-75 m in length) with openings at certain areas through which the radiation can leave the waveguide and impact onto the heatable and absorbing membrane containing CNTs. Various magnetrons can be placed near each other, and they may be coupled to waveguides of different lengths, such as one magnetron coupled a waveguide from which the first 10 m of a wing is irradiated, the second coupled to a 20 m long waveguide, with openings for radiation between 10 and 20 m, and so forth. The waveguides can serve as construction element, especially in airplane wings. Specifically, waveguides can replace metallic conductors (copper cable) which are used as lightning protection and conductor to ground. Preferably in this case, the waveguides would be in electrical connection to lightning receivers at the outside of the blades, e.g. copper bolts protruding from the blade surface at various points. The fact that a lightning event may destroy the magnetrons attached to the waveguides is acceptable as the economic loss is not significant.

Sensors which detect ice accretion can placed onto the wing. Signals from the one or more sensors may trigger deicing by radiation, and they may also signal potential overheating such that the radiation is interrupted or stopped.

Compared with other solutions, such as electro-thermal heating or using hot air in the hollow structure of the blade, the according to the invention saves energy, costs and weight. Magnetrons are available at low costs, they weigh little, operate using 220 V, and they are easily placed and mounted within the wing structure. They can be isolated from the lightning protection system such that wind turbine blades and the heating system described here are protected during lightning events. The coating comprising CNT is relatively cheap to produce and easily applied in various forms, e.g. as viscous coating, polymerized during production, or as continuous tape or felt. The production technique fits to other production steps in the wind turbine industry.

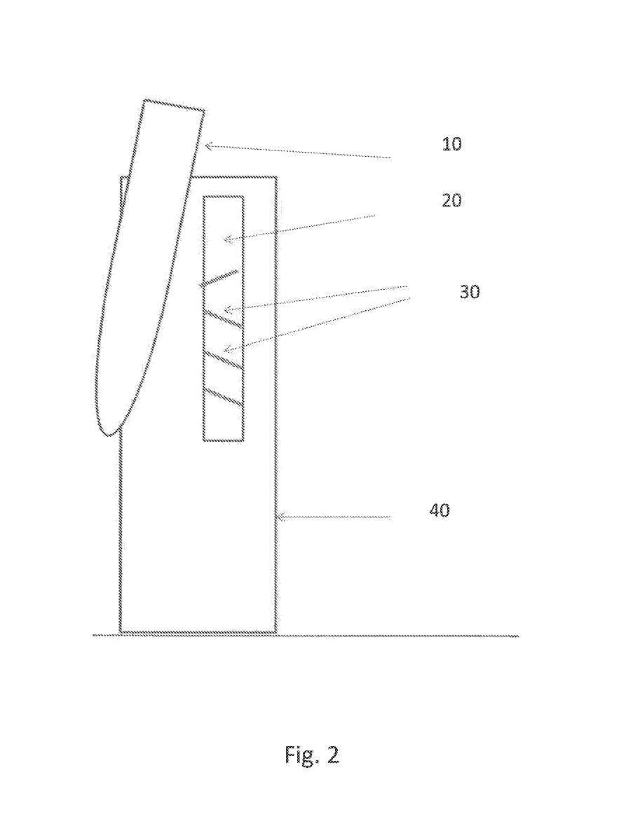

Another preferred embodiment is shown schematically in FIG. 2. On a tower 40, at least one magnetron with power supply (not shown) and at least one waveguide 20, with slots 30 where radiation emerges, is placed such that a wing 10 can be irradiated on the outside. The wing 10 which should be deiced is turned down and rotated by changing the pitch angle and simultaneously irradiated. The coating on the wing absorbs radiation, is heated and ice is gradually melted. Preferably and for safety reasons, to avoid ice from being thrown, one wing is deiced while it is facing downwards, parallel to the tower and the waveguide, such that melted ice can fall directly to the ground. During deicing, the wing can be rotated around its internal axis such that the whole blade surface may be deiced, using the engine changing the pitch of the blade. At the top of the tower, where the blade surface is larger, more waveguides can be placed. The waveguide arrangement can be mounted such that it can be rotated or moved around (or up and down) the tower to any position between the tower 40 and the wing 10. Power is preferably supplied from the ground level.

This construction has the advantage, especially for retrofitting turbines lacking deicing functionality, that no internal changes are required in the turbine and blade construction, except that the wing needs to be covered or painted with the composition or membrane according to the invention. This can be done by sky lift and repair teams. Using 10 kW electrical input, deicing of one wing can be accomplished within. 5-20 minutes. Thereafter wing No. 2 and wing No. 3 are deiced. Deicing can be automatic. At given wind speed, icing is indicated e.g. by a drop in the turbine performance, or by a change in the vibrational spectrum which indicates extra weight. At that time, a deicing sequence may be started automatically. A potential disadvantage of this embodiment could be the fact that radiation is emitted which may not be absorbed by the wing. However, radiation can be directed by proper waveguide construction, thereby reducing losses. As far as safety is concerned, radiation levels decrease with the square of the distance. The lowest possible distance to humans working near the turbine is 20 m. If one microwave emitter emits 1000 W at 20 m height, the radiation level at ground will be below 10 W/m2 which is the accepted safety level. Due to the fact that only a very little mass, such as 40 kg per wing, requires heating by e.g. 20 degree C., the total power requirement is very low.

Deicing can be monitored by sensors monitoring the surface temperature of the wing during deicing.

### EXAMPLE 2

Aircraft wings: The solution resembles the solution for wind. turbine blades except that aircraft wings usually contain fuel. Therefore special precautions are used to separate the fuel volume from the volumes irradiated by the magnetrons, and to insulate all electrical connections to the magnetrons or IR radiators from contact with fuel. However, typically it is sufficient to heat the leading edge of aircraft wings such that the volume requirement is limited. In addition, the waveguide for microwaves (see example 1) can also serve as construction material (both in wind power and airplane wings). It can also serve as lightning receiver or conductor, see above.

### EXAMPLE 3

Overhead power lines: Power lines can be coated with a composition containing CNTs and the strong current combined with high voltage induces currents in the conductive particles causing heating of the coating. Especially alternating current is effective in electromagnetic induction. Useful polymeric materials to embed the CNTs are polyurethane, some epoxy types, and silicone rubber. Preferred are elastic materials as power lines expand with temperature variations and move and deform in strong winds.

### EXAMPLE 4

All materials absorbing infrared or microwave radiation or able to absorb electromagnetic fields by induction described in the above examples may be coated for different reasons: in the wind industry, the preferred top coating is non-glossy, and white to off-white. Therefore, a thin paint coating covering the black colour of the absorbing material is preferred, and said top coating may contain heat conductive additives. The same is true in the aircraft industry, where leading-edge foils providing erosion resistance are preferably used. Overhead power lines are preferably coated with hydrophobic materials providing erosion and UV resistance. Weakly conductive or antistatic coatings are preferred as they, in general, are less dust- and dirt-collecting than insulating coatings.

Compared to the prior art, the deicing solution according to the invention has considerable advantages. Magnetrons and IR heaters are cheaply available commercially, and they are low in weight, and efficient in performance. Thus, even a plurality of magnetrons can be placed in a large wind turbine blade without adding more than 100-500 kg in weight. Supply of electricity is limited to the inner structure of the blade, providing protection against lightning events. The composition according to the invention may cover a whole wind power blade (length 75 m, 3 m average wide, 2 sides) with a thickness in the order of 0.1 mm, and will add ca. 40 kg in weight to the blade. Assuming that this coating needs to be heated by 30 degree C. in a harsh winter, the required electrical input is 3600 kJ, i.e. 180 W over a period of 20 seconds. Here it is assumed that all loss processes are negligible, including absorption by the composite structure, magnetron efficiency, cooling losses by wind, losses in the waveguides etc. Most importantly, some energy is required to accomplish the melting of a portion of ice directly attached to the wing. A 0.05 mm thick ice film (ca 20 kg) also requires some 6600 kJ energy for the phase transition solid→liquid (latent heat of melting=334 kJ kg ice). It is assumed that ice will detach from the wing by the impact of wind, or because the liquid film provides no longer adhesion of ice to the wing. Still, in summary, an energy requirement in the order of 15 000 kJ (7.5 kW over a period of 33 minutes) is deemed to be sufficient even for rough climatic conditions.

In the case of overhead power lines, a coating of metal conductors provides corrosion resistance, and the electromagnetic induction of currents in the composition allows to provide deicing without requiring external power supplies, provided the current in the conductor is high enough to achieve induction.

A wide range of frequencies can be used, e.g. between 500 MHz to 30 GHz. Ideally frequencies are chosen which do not interfere with radio and other communication, and also frequencies which are not absorbed by materials through which the radiation has to pass 1-5 GHz is a particularly useful frequency as polymers show only weak absorption in this frequency spectrum. 2.45 GHz is a particularly preferred frequency. The heatable films or compositions can be equipped with temperature sensors such that excessive heating is avoided.

A specific advantage or positive side effect of a conductive membrane according to the invention is reduced interference with weather and other radar installations. Today, wind turbines interfere with radar installations. The membrane or microwave-absorbing composition according to the invention absorbs radar radiation, therefore a wind turbine equipped with said novel material will essentially be “transparent” for radar radiation, i.e. it will not reflect radiation. Wind turbines could be equipped with signal emitters to alert pilots in aircrafts flying at low altitude.

The method is highly economic both in production and operation, and the method is suitable for retro-fitting existing wind turbines which lack a deicing function.

1. A method for deicing of a surface of a structure in general and predominantly made of polymeric materials which requires deicing at certain times, comprising the steps of:
providing a composition comprising at least one material heatable by microwave or infrared radiation or electromagnetic induction,
placing the composition close to an area of said structure in general, whereby the composition may undergo chemical reaction such as polymerization or hardening before, during or after placing the composition at said area, and whereby said composition may be covered by a paint, a gel coat, a foil or other protect ion,
heating said composition as and when required without direct electrical contact, said heating being achieved by microwave or infrared irradiation or electromagnetic induction.

2. The method according to claim 1, wherein said at least one material is selected from the group consisting of carbon nano tubes, carbon horns, carbon cones, graphite, metal coated glass beads and or electrically conductive particles such as metal powder, carbon fibers, alone or in mixtures or in mixture with metal powder, all collectively named Carbon Nano Tubes (CNTs), and metalized CNTs.

3. The method according to claim 14, wherein said structure is selected from the group consisting of wind turbine blades, aircraft wings, other aircraft parts, marine structures, composites and overhead power lines.

4. The method according to claim 1, wherein said composition further comprises a thermoplastic such as polyethylene, polypropylene, PET, polycarbonate or a thermoset such as polyurethane, epoxy or phenolic resin or rubber such as vulcanized rubber, thermoplastic elastomer, polyurethane rubber or silicone rubber, and optionally filler such as heat conductive materials such as boron nitride.

5. The method according to claim 1, wherein said CNTs form part of the composition with at least 0.5% by weight or at least so much that at least 10% of the emitted IR or microwave radiation is absorbed thereby heating the composition, whichever percentage is the lower.

6. The method according to claim 1, wherein the composition is applied as a coating of between 10 micrometer and 1 millimeter thickness, or as prefabricated coating on glass fiber or textile.

7. The method according to claim 1, wherein a plurality of magnetrons is used to achieve heating of said composition, which forms part of the outer surface of said structure in general.

8. The method according to claim 1, wherein the radiation source is placed at the inside of said structure in general in case of a hollow structure or is placed outside of said structure in general.

9. The method according to claim 1, wherein at least one suitable shielding element is applied to prevent induction of electrical currents in metal parts such as lightning receivers or metallic, components.

10. The method according to claim 3, wherein mainly polymeric or composite aircraft wings, especially the leading edges, or other aircraft parts are deiced, or where overhead power lines being deiced using heating of CNTs by electromagnetic induction from, the power lines.

11. Use of a composition obtained by the method according to claim 1 to achieve heating or deicing, or to reduce radar-interference.

12. A composition obtained by the method according to claim 1.
